(19) United States
(12) Patent Application Publication
(10) Pub. No.: US 2026/0184131 A1
(43) Pub. Date: Jul. 2, 2026

(54) HYDRAULIC HEIGHT ADJUSTMENT DEVICE OF A MOTOR VEHICLE AND MOTOR VEHICLE

(71) Applicant: Vibracoustic SE, Weinheim (DE)

(72) Inventor: Dennis Vogt, Lüneburg (DE)

(21) Appl. No.: 19/307,287

(22) Filed: Aug. 22, 2025

(30) Foreign Application Priority Data
Aug. 23, 2024 (DE) 10 2024 124 241.8

(51) Int. Cl. B60G 17/056

(52) U.S. Cl. CPC B60G 17/0565; B60G 2500/30

(57) ABSTRACT

A hydraulic height adjustment device of a motor vehicle includes at least one hydraulic pump arrangement connected via feed branch to at least two actuators for adjusting a vehicle level. A hydraulic fluid may be pumped from a tank arrangement into at least one of the at least two actuators. A switching valve may be connected upstream of the actuators to permit or prevent an inflow or outflow of hydraulic fluid. The at least two actuators may be connected via a return branch to the at least one tank arrangement. A pilot pressure-controlled return valve may be configured to hold the return branch open below a defined switching pilot pressure, and the return valve may hold the return branch closed at or above the switching pilot pressure. A pilot pressure line, via which a pilot pressure can be supplied, may be provided between the pump arrangement and the return valve.

### CROSS-REFERENCE TO RELATED APPLICATION

This application claims priority to German Patent Application No. DE 10 2024 124 241.8, filed on Aug. 23, 2024, the contents of which is hereby incorporated by reference in its entirety.

### TECHNICAL FIELD

The present disclosure relates generally to hydraulic height adjustment devices, including hydraulic height adjustment devices for motor vehicles and related vehicle systems.

### BACKGROUND

Certain aspects of hydraulic height adjustment devices of motor vehicles and motor vehicles of the type mentioned in the introduction are described in the prior art.

Some pneumatic height adjustment devices may have an electronically activatable return valve in a return branch. During the lifting or inflation, an electrical switching valve which is assigned to a strut may be opened, while the electrically activatable non-return valve may be closed. If air or pressure is to be released from the air spring, the electronic non-return valve and the electrical switching valve assigned to the respective air spring are opened until the desired vertical position is reached. This principle is also applicable in hydraulic solutions.

Electronic switching valves can be relatively expensive. The price can rise, for example, with the size of the switching valve, which in turn may be substantially dictated by the maximum flow rate. In the case of a purely rear axle solution, the valve consequently can include sufficiently large dimensions in order to produce the flow rate for two air springs at the same time; however if the front and rear axle are provided with air springs, a return line which may be twice as large and thus also a correspondingly large return valve may be included in order to achieve the same lowering rate.

KR 10 2024 009 3011 A describes switching valves on the pressure release side.

A drawback may be that all of the actuators need to be lifted uniformly via the pressure feed for a sufficient length of time until the last of the actuators has reached the target height. Subsequently the other actuators, which in principle have too high a level, are drained again to the target level. Although this principle eliminates a switching valve, ultimately in a solution for four actuators, or actuators on the front and rear axle, it frequently arises that three actuators initially have to be overfilled with fluid until the last actuator is at the target level. Subsequently the first three actuators have to be drained again which reduces the convenience, slows down the adjustment of the desired level and unnecessarily wastes energy. Moreover, due to the variable length of the feeds to the front and rear axle actuators, the pressure losses in the lines may have to be compensated since otherwise in principle the actuators with the lower pressure losses may have to be overfilled first before the other actuators move.

### SUMMARY

Certain embodiments provide hydraulic height adjustment devices of motor vehicles and motor vehicles, including the type mentioned in the introduction such that an electronically switched valve can be eliminated, and it can be beneficial to be able to operate purely rear axle systems and multi-axle systems.

The foregoing may be achieved by a hydraulic height adjustment device of a motor vehicle such as disclosed herein.

A hydraulic height adjustment device of a motor vehicle as described may have at least one hydraulic pump arrangement which may be connected via a feed branch to at least two actuators for adjusting a vehicle level of the motor vehicle, by a hydraulic fluid being able to be pumped by means of the pump arrangement from at least one tank arrangement into at least one of the at least two actuators, wherein in each case at least one switching valve may be connected upstream of the actuators in order to permit or to prevent an inflow or outflow of hydraulic fluid, wherein the at least two actuators are connected via a return branch to the at least one tank arrangement, wherein a pilot pressure-controlled return valve, which may be configured such that it holds the return branch open below a defined switching pilot pressure, may be provided, wherein the return valve holds the return branch closed at or above the switching pilot pressure, wherein a pilot pressure line, via which a pilot pressure can be supplied, may be provided between the pump arrangement and the return valve.

The pilot pressure-controlled return valve may be designed to open or to close the return branch, as required. The pressure of the pilot pressure line may be used for the opening or closing, wherein the return valve may be opened at a pilot pressure below the switching pilot pressure and closes at or above the switching pilot pressure.

By using a pilot pressure-controlled return valve it may be possible to avoid the use of a further expensive electronic switching valve, in particular one which may need a large flow volume of hydraulic fluid, such as may be required for example in the case of a multi-axle solution.

In this manner it may be possible to equip the hydraulic height adjustment device both for motor vehicles with a hydraulically height-adjustable rear axle or with a plurality of hydraulically height-adjustable axles, wherein specific components optionally have to be scaled to the number of height-adjustable axles, but the pilot pressure-controlled return valve can be dimensioned more advantageously than corresponding valves which are switched electronically. This may be applicable, in particular, since with pilot pressure-controlled switching valves the required switching forces do not necessarily correlate with the cross section to be switched.

The corresponding pilot pressure can be provided by the pump arrangement or by a separate pressure-generating arrangement which may serve exclusively for actuating the pilot pressure-controlled return valve or optionally can also be used for other purposes.

The tank arrangement can be an individual tank, a plurality of tanks or an individual tank or a plurality of tanks with optionally provided additional tanks, for example expansion tanks. Expansion tanks can compensate for fluctuations in the volume of the hydraulic fluid which arise, for example, due to temperature variations or the operation of the vehicle.

The pump arrangement can have a motor and a hydraulic pump. The pump arrangement may be designed to convey the hydraulic fluid at sufficiently high pressure to the at least two actuators.

In a first further embodiment, a pressure buffer, which reduces pressure peaks in the event of pressure changes in the feed branch of the hydraulic system, may be provided.

In another further embodiment, an admission pressure valve, which releases a fluid flow to the at least two actuators only above a minimum pressure, may be connected upstream of the at least two actuators in the feed branch, wherein the pilot pressure line may be arranged between the pump arrangement and admission pressure valve, on the one hand, and the return valve, on the other hand.

In this manner, a pressure can be built up in the hydraulic fluid between the pump arrangement and admission pressure valve.

The admission pressure valve can be a spring-loaded valve, wherein different spring types are relevant, such as for example spiral or plate springs, which can be both tension springs and compression springs in a corresponding arrangement. In certain embodiments, the spring force can be adjustable, for example by adjusting a pretensioning of the spring.

In another further embodiment, a bypass may be provided for releasing pressure in the pilot pressure line after switching off the at least one pump arrangement.

This is because over the course of time the line pressure may be reduced between the pump arrangement and the pilot pressure-controlled return valve, so that the pilot pressure-controlled return valve opens again.

In another further embodiment, the bypass may be configured in the return valve and produces a fluidic connection between the pilot pressure line and the return branch.

In this manner, a separate bypass can be dispensed with.

In another further embodiment, the bypass may be configured as a groove or bore in the valve body.

This may eliminate additional components and/or production steps.

In certain embodiments, the bypass can also be configured in the valve housing or in the valve seat or the like.

In another further embodiment, the bypass may produce a fluidic connection in the feed branch between the pump arrangement and the admission pressure valve, on the one hand, and the return branch between the non-return valve and the tank arrangement, on the other hand.

In another further embodiment, the return valve may include a valve body which may be loaded by a spring and which may be held in an open position by the spring, wherein the valve body may be moved into a closed position by the switching pressure.

Different types of springs are relevant, such as for example spiral springs, which can be both tension springs and compression springs in a corresponding arrangement. In certain embodiments, the spring force can be adjustable, for example by adjusting a pretensioning of the spring.

In another further embodiment, the valve body may be a valve ball, a valve tappet or a valve cylinder.

In another further embodiment, an overpressure line, which is shut by a pressure relief valve in normal operation, may be provided between the pump arrangement and the return branch.

In another further embodiment, the at least two actuators in each case may contain at least one fluid chamber which may be defined at least in some portions in each case by at least one elastomer bellows with a rolling fold, wherein the hydraulic system may be configured such that the entire fluid flow of hydraulic fluid flows together through the one return valve into the return branch when one or more of the at least two actuators are retracted.

Relative to other systems, in bellows systems high volume flows tend to be required in the case of low pressures, while, for example in piston-based constructions, the pressures tend to be higher but the volume flows are consequently smaller. The use of a pilot pressure-controlled valve may be particularly advantageous here, since the volume flows to be switched and the required switching forces are not necessarily linked here. This may be because the switching forces are not generally oriented in the direction of the locking force, but transversely thereto, so that they are independent of the locking force. In electronically switched valves, however, the locking forces are generally arranged in the direction of the switching forces so that large cross sections to be switched lead to high switching forces and, as a result, large, expensive components are also required, such as large copper coils.

A first independent subject relates to a motor vehicle having a hydraulic height adjustment device as claimed in one of the preceding claims of the type described above.

### BRIEF DESCRIPTION OF THE DRAWINGS

Further features, details and advantages of the invention are found in the wording of the claims and in the following description of exemplary embodiments by way of the drawings. In the drawings, schematically:

FIG. 1 shows a plan view of an embodiment of a motor vehicle with a hydraulic height adjustment device;

FIG. 2 shows a circuit diagram of an embodiment of a hydraulic height adjustment device for a single-axle system;

FIG. 3 shows a circuit diagram of the hydraulic height adjustment device of FIG. 1 for a twin-axle system;

FIG. 4 shows a pilot pressure-controlled return valve in a first embodiment, and

FIG. 5 shows a pilot pressure-controlled return valve in a second embodiment.

### DETAILED DESCRIPTION

In the exemplary embodiments described hereinafter, components or elements which are the same or have the same function are provided with the same reference signs for greater clarity.

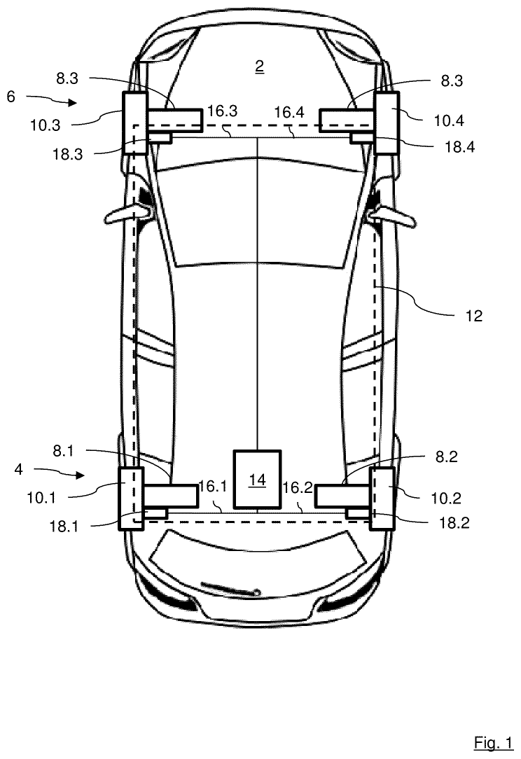

FIG. 1 shows a plan view of a motor vehicle 2.

The motor vehicle 2 may include a rear axle 4 and a front axle 6. The motor vehicle 2 may include a chassis with chassis arrangements 8.1, 8.2, 8.3, 8.4, wherein the chassis arrangement 8.1 may be provided for a left-hand rear wheel 10.1, the chassis arrangement 8.2 may be provided for a right-hand rear wheel 10.2, the chassis arrangement 8.3 may be provided for a left-hand front wheel 10.3 and the chassis arrangement 8.4 may be provided for a right-hand front wheel 10.4. The respective chassis arrangements 8.1, 8.2, 8.3 and 8.4 are height-adjustable by means of a hydraulic height adjustment device 12.

The hydraulic height adjustment device 12 may include a control arrangement 14 which may include both the control logic and the required fluid-conveying components. In various embodiments, the control arrangement 14 can be arranged in one or more housings. The control arrangement 14 may be connected by means of feed lines 16.1, 16.2, 16.3 and 16.4 to actuators 18.1, 18.2, 18.3 and 18.4, which may be arranged in each case on the chassis arrangements 8.1, 8.2, 8.3 and 8.4 or may be constituent parts thereof.

The components of the height adjustment device 12 and, in particular, the control arrangement 14 are explained in more detail in the following description of the figures. The vehicle level of the motor vehicle 2 can be lifted or lowered individually on each individual wheel 10.1 to 10.4 by means of the hydraulic height adjustment device 12 in order to lift or lower the level on one or both of the axles 4, 6 or optionally to compensate for the level on individual wheels 10.1 to 10.4, for example in the case of different loads, due to the cargo or due to the passenger distribution.

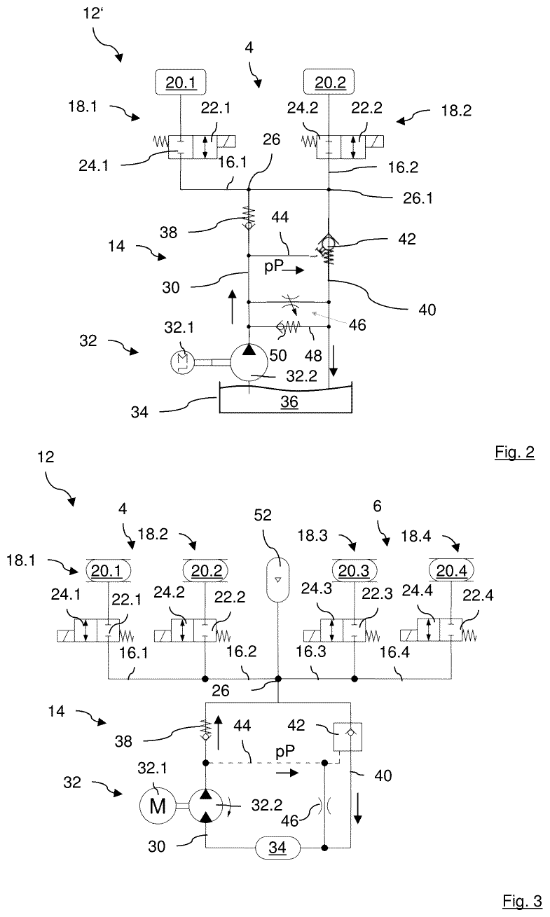

FIG. 2 shows a circuit diagram of a hydraulic height adjustment device 12′ for a single-axle system, generally for a rear axle 4 of a motor vehicle.

The actuators 18.1 and 18.2 have in each case fluid chambers 20.1 and 20.2 which can be filled with hydraulic fluid and from which hydraulic fluid can be drained. When filling with hydraulic fluid the volume of the fluid chambers 20.1, 20.2 correspondingly increases, whereby the corresponding chassis arrangement 8.1, 8.2 may be lifted.

In each case solenoid valves 22.1 and 22.2, which are opened or closed on the basis of data from a respective level sensor 24.1 and 24.2, may be provided for controlling the filling of the fluid chambers 20.1 and 20.2. The respective level sensor 24.1 and 24.2 transmits its data to a central controller, not shown, which decides for each correspondingly equipped wheel 10.1, 10.2 whether it is to be lifted or lowered. This can be regulated automatically and/or influenced by user preferences, amongst other things.

The actuators 18.1 and 18.2 are fluidically connected by means of the lines 16.1 and 16.2 via a distributor 26 to a feed branch 30 which can pump hydraulic fluid 36 by means of a pump arrangement 32 from a tank 34 in the direction of the actuators 18.1 and 18.2.

The pump arrangement 32 may include a motor 32.1 and a pump 32.2 which can generate a hydraulic pressure by the hydraulic fluid 36, whereby it may be possible to fill the respective fluid chambers 20.1 and 20.2 when the level on the axle 4 may have to be lifted.

An admission pressure valve 38 may also be arranged in the feed branch 30, said admission pressure valve holding the feed branch 30 closed for a sufficient length of time until a certain minimum pressure or switching pressure is reached, at which the admission pressure valve 38 opens. Below this minimum pressure it is not possible to convey hydraulic fluid 36 to the actuators 18.1, 18.2 or into the fluid chambers 20.1 and 20.2.

The actuators 18.1 and 18.2 are also connected via the lines 16.1, 16.2 to a return branch 40, via which the hydraulic fluid 36 can be routed back into the tank 34.

A pilot pressure-controlled return valve 42, such as described in more detail below, may be arranged in the return branch 40. If the level of the corresponding height-adjustable rear axle 4 or a wheel 10.1, 10.2 thereof is to be lowered, the corresponding solenoid valves 22.1 and/or 22.2 are opened, wherein, when the return valve 42 is opened, the hydraulic fluid 36 may be forced through the return branch 40 into the tank 34 due to the weight force of the motor vehicle.

The tank 34 can be an individual tank or a multi-part tank which may include an expansion tank.

The feed branch 30 and return branch 40 merge with one another at the distributor 26 or 26.1. In certain embodiments, the distributors 26 and 26.1 can be combined together in one component or, as shown here, at two distributor points, wherein the line portion between the intersections 26 and 26.1 serves as a feed or as a return depending on the operating mode.

A branching, from which a pilot pressure line 44 leads to the pilot pressure-controlled return valve 42, may be provided in the feed branch 30 between the pump arrangement 32 and the admission pressure valve 38. A pilot pressure pP may be provided via the pilot pressure line 44. The pilot pressure-controlled return valve 42 may be configured such that it may either be shut or open depending on the respective pilot pressure pP. The pilot pressure-controlled return valve 42 may be configured such that it may be open in the case of a pressure below a switching pilot pressure pS (see, eg., FIG. 5). In other words, in this state hydraulic fluid 36 can drain into the tank 34 via the return branch 40. The return valve 42 may be switched by means of the pilot pressure line 44 into a shut state at and above the switching pilot pressure pS, so that the return branch 40 may be closed and hydraulic fluid 36 can no longer drain into the tank 34.

The switching pressure of the admission pressure valve 38 may be above the switching pilot pressure pS, so that the admission pressure valve 38 may only open when the pressure may be sufficiently high to hold the pilot pressure-controlled return valve 42 closed.

As the feed branch 30 is shut by the admission pressure valve 38 before a sufficient pressure may be generated, initially at least the switching pilot pressure pS can be built up and provided by means of the pump arrangement 32, the pilot pressure-controlled return valve 42 initially being closed thereby. In the case of the subsequent further rise in pressure, the admission pressure valve 38 opens and no hydraulic fluid 36 can be conveyed via the feed branch 30 to the actuators 18.1 and 18.2. In this state, the pressure at the return valve 42 remains higher than the switching pilot pressure pS. Accordingly, the pilot pressure-controlled return valve 42 remains closed, so that when the fluid chambers 20.1, 20.2 are filled with hydraulic fluid 36, it cannot lead to a significant pressure loss at this point.

The pump arrangement 32 remains activated for a sufficient length of time until the corresponding chassis levels are reached on the wheels 10.1, 10.2. As soon as this is the case, the solenoid valves 22.1 and 22.2 close and the volumes of the corresponding fluid chambers 20.1 and 20.2 are defined.

A bypass 46 may be provided to compensate for an overpressure in the feed branch 30, built up by pumping the hydraulic fluid 36 after the pump arrangement 32 has been actuated, the corresponding overpressure between the pump arrangement 32 and the actuators 18.1 and 18.2 being able to be released by said bypass. If the pilot pressure pP drops below the switching pilot pressure pS, the pilot pressure-controlled return valve 42 transfers into the opened state.

In order to lower the level on the axle 4, the solenoid valves 22.1 and 22.2 are opened so that the hydraulic fluid 36 can flow out of the respective fluid chambers 20.1 and 20.2 and can be routed into the tank 34. Once the desired level is reached, the respective solenoid valves 22.1, 22.2 are closed. This can be controlled individually for each wheel 10.1, 10.2 by the solenoid valves 22.1, 22.2, as when lifting the levels. If the level on one of the wheels 10.1, 10.2 were to be lifted or lowered to a greater or lesser extent, the corresponding solenoid valve would remain open for a correspondingly longer or shorter time.

To prevent damage, an overpressure protection means, in the form of an overpressure line 48 and a pressure relief valve 50, may be provided between the feed branch 30 and return branch 40. The pressure relief valve 50 opens in a pressure situation which may be outside the usual operating parameters of the hydraulic height adjustment device 12, but still below the possible burst limits of the corresponding lines, valves and actuators. This may be important, such as, for actuators having elastomer bellows and at least one rolling fold, since they have relatively low burst pressures. Thus damage to the corresponding hydraulic height adjustment device 12 can be prevented.

FIG. 3 shows a circuit diagram of the hydraulic height adjustment device of FIG. 1 for a twin-axle system. In order to avoid repetition, reference is made to the corresponding description of the hydraulic height adjustment device 12′ of FIG. 2.

The actuators 18.3 and 18.4 on the front axle 6 are configured in each case as the actuators 18.1 and 18.2 on the rear axle 4, which is why a detailed description is dispensed with and reference is instead made to the corresponding principle description of FIG. 2. The dimensioning of the actuators 18.1, 18.2, on the one hand, and 18.3 and 18.4, on the other hand, however, can be different in practice in order to take account of different lifting and loading requirements, for example in utility vehicles with a high additional load on one of the axles 4, 6.

In contrast to FIG. 2, only one intersection 26.1, at which the feed branch 30 and the return branch 40 merge with one another, may be provided in the present case.

The levels on the individual wheels 10.1 to 10.4 can be respectively changed, for example lifted or lowered, by the selective shutting of the corresponding solenoid valves 22.1 to 22.4, or the opening thereof.

Moreover, a pressure buffer 52, which serves to avoid pressure peaks in the hydraulic system during the switching, may be provided. Such a pressure peak can arise, for example, when the admission pressure valve 38 or the pilot pressure-controlled return valve 42 may be switched. A corresponding pressure buffer can also be provided in the hydraulic height adjustment device 12′ of FIG. 2.

A separate overpressure protection means is not shown in the hydraulic height adjustment device 12. In different variants, however, this can be correspondingly added or simply designed in a different form, for example on the pump 32.2 or the pilot pressure-controlled return valve 42.

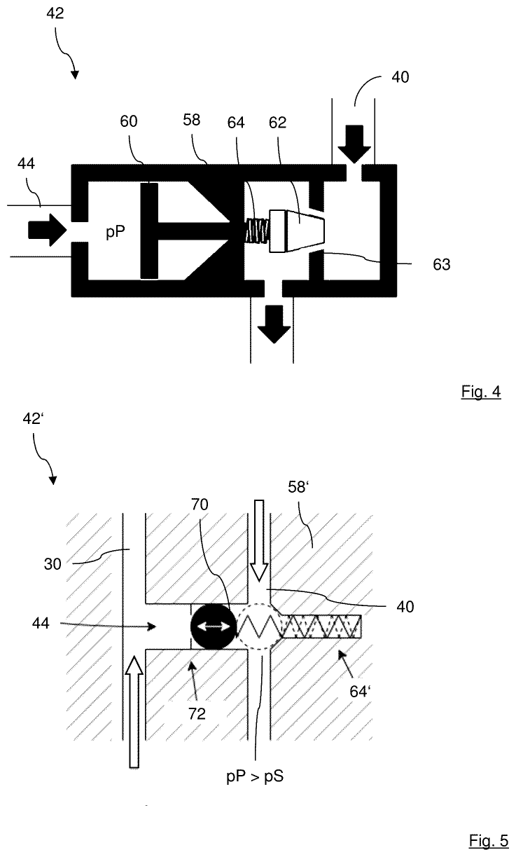

FIG. 4 shows a pilot pressure-controlled return valve 42 in a first embodiment.

The pilot pressure-controlled return valve 42 may include a housing 58 in which a valve tappet 60 may be axially movably arranged. The valve tappet 60 moves a valve body 62 which may be connected thereto and which together with a valve seat 63 permits an opening or a closing of the return branch 40.

The valve tappet 60 may be pretensioned counter to the closing direction by a tension spring 64, so that when the pilot pressure pP may be absent, the corresponding pilot pressure-controlled return valve 42 may be opened. In embodiments, only when the pilot pressure PP reaches the switching pressure SP might the tension spring 64 be sufficiently expanded and the valve body 62 lies sealingly in the valve seat 63, whereby the return branch 40 may be closed.

In alternative embodiments, instead of a tension spring 64, it may be possible to arrange a compression spring which acts in the opposing direction and pretensions the valve tappet 60 and the corresponding valve body 62 into the open position.

FIG. 5 shows a pilot pressure-controlled return valve 42′ in a second embodiment.

The pilot pressure-controlled return valve 42′ may be integrated to a greater extent than the pilot pressure-controlled return valve 42 of FIG. 4. Thus the feed branch 30 and the return branch 40 may be guided in each case through a corresponding housing 58′ of the pilot pressure-controlled return valve 42′. The pilot pressure line 44 may also be integrated in the housing 58′. The housing 58′ can be cast.

A valve ball 70 which may be pushed against a stop 72 by means of a compression spring 64′ in the case of low pilot pressures pP is used as a valve body. In embodiments, only when the pilot pressure pP may be greater than the switching pilot pressure pS is the spring 64′ sufficiently compressed so that the return branch 40 may be shut by the valve ball 70. If the pilot pressure pP drops again, the valve ball 70 may open the return branch 40 again.

A bypass, for example in the form of a groove, which may be formed separately or between the pilot pressure line 44 and the return branch 40 can also be integrated in this embodiment.

Alternatively, a groove can be configured in the corresponding valve body 62; 70 in this embodiment and in the embodiment described in FIG. 4 in order to prevent a perfect seal on the respective valve seat 63.

The invention is not limited to one of the above-described embodiments but can be modified in many different ways.

All of the features and advantages found in the claims, the description and the drawing, including structural details, spatial arrangements and method steps, can be essential to the invention both per se and also in a wide variety of combinations.

1. A hydraulic height adjustment device of a motor vehicle having at least one hydraulic pump arrangement which is connected via a feed branch to at least two actuators for adjusting a vehicle level of the motor vehicle, by a hydraulic fluid being able to be pumped by means of the pump arrangement from at least one tank arrangement into at least one of the at least two actuators, wherein in each case at least one switching valve is connected upstream of the actuators in order to permit or to prevent an inflow or outflow of hydraulic fluid, wherein the at least two actuators are connected via a return branch to the at least one tank arrangement, wherein a pilot pressure-controlled return valve, which is configured such that it holds the return branch open below a defined switching pilot pressure, is provided, wherein the return valve holds the return branch closed at or above the switching pilot pressure, wherein a pilot pressure line, via which a pilot pressure can be supplied, is provided between the pump arrangement and the return valve.

2. The hydraulic height adjustment device as claimed in claim 1, wherein a pressure buffer, which reduces pressure peaks in the event of pressure changes in the feed branch of the hydraulic system, is provided.

3. The hydraulic height adjustment device as claimed in claim 1, wherein an admission pressure valve, which releases a fluid flow to the at least two actuators only above a minimum pressure, is connected upstream of the at least two actuators in the feed branch, wherein the pilot pressure line is arranged between the pump arrangement and admission pressure valve, on the one hand, and the return valve, on the other hand.

4. The hydraulic height adjustment device as claimed in claim 1, wherein a bypass is provided for releasing pressure after switching off the at least one pump arrangement.

5. The hydraulic height adjustment device as claimed in claim 4, wherein the bypass is configured in the return valve and produces a fluidic connection between the pilot pressure line and return branch.

6. The hydraulic height adjustment device as claimed in claim 5, wherein the bypass is configured as a groove or bore in the valve body.

7. The hydraulic height adjustment device as claimed in claim 4, wherein the bypass produces a fluidic connection in the feed branch between the pump arrangement and the admission pressure valve, on the one hand, and the return branch between the non-return valve and the tank arrangement, on the other hand.

8. The hydraulic height adjustment device as claimed in claim 1, wherein the return valve has a valve body which is loaded by a spring and which is held in an open position by the spring, wherein the valve body is moved into a closed position by the switching pressure.

9. The hydraulic height adjustment device as claimed in claim 8, wherein the valve body is a valve ball, a valve tappet or a valve cylinder.

10. The hydraulic height adjustment device as claimed in claim 1, wherein an overpressure line, which is shut by a pressure relief valve in normal operation, is provided between the pump arrangement and the return branch.

11. The hydraulic height adjustment device as claimed in claim 1, wherein the at least two actuators in each case contain at least one fluid chamber which is defined at least in some portions in each case by at least one elastomer bellows with a rolling fold, wherein the hydraulic system is configured such that the entire fluid flow of hydraulic fluid flows together through the one return valve into the return branch when one or more of the at least two actuators is retracted.

12. A motor vehicle having a hydraulic height adjustment device as claimed in claim 1.
